(19) United States
(12) Patent Application Publication
(10) Pub. No.: US 2005/0122977 A1
(43) Pub. Date: Jun. 9, 2005

(54) Efficient download mechanism for devices with limited local storage

(75) Inventor: Bruce Louis Lieberman, Bellevue, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/729,708

(22) Filed: Dec. 5, 2003

(51) Int. Cl. H04L 12/56

(52) U.S. Cl. 370/394; 370/420

(57) ABSTRACT

A method and system for downloading data from a one device to another. First, a device broadcasts a discovery packet that informs servers that data desired. Then servers send offer packets to the device, informing it that they are prepared to download data. The device chooses an offer and sends a start packet. The chosen server may then send the device a selected limit of data packets. The device will send acknowledgements to the server before it has received the server's selected limit. Upon receiving an acknowledgement, the server may again send up to the limit of data packets before again waiting for acknowledgement. For example, if the server is permitted to send a limit of 8 packets, the device may send an acknowledgement every 4 packets. This shortens download time by allowing server and device to operate simultaneously.

### FIELD OF THE INVENTION

The present invention relates to computing, and more particularly to downloading data to devices with little or no secondary memory.

### BACKGROUND OF THE INVENTION

Many electronic devices have been created that reduce the cost of goods by not storing an operating system, or by storing a partial, or minimalist operating system locally. Such systems may instead store a small program that downloads an operating system over a network. This occurs every time the device is powered up.

For example, diskless personal computer (“PC”) is defined as a computer without any local storage media, i.e., no floppy or hard drive. Normally a diskless PC uses a Local Area Network, or LAN-based boot server to provide the operating system from which the diskless PC can boot. A diskless PC also may use a network adapter interface and boot Read Only Memory (“ROM”) (also known as boot PROM) to communicate with the boot server. The process of booting a diskless PC or terminal is known as remote booting or network booting (LAN boot).

Another example is the “Bobsled,” a low cost remote playback device for audio and video created by MICROSOFT®. The bobsled extends the capabilities of the Windows Media Center Edition (“MCE”) throughout the house. As a low cost device, Bobsled cannot afford to keep its operating system in local storage (both flash memory and disk memory are too expensive). Since it is on a network, however, it has the luxury of being able to download its operating system from the MCE, which functions as a server for the Bobsled.

Devices such as the diskless personal computer and the Bobsled usually follow the Bootstrap Protocol (“BOOTP”) process to obtain their operating system when powered up. The BOOTP process involves first using Dynamic Host Configuration Protocol DHCP”) to get an IP address, then using the Address Resolution protocol (“ARP”) to verify that no other device is using the IP address, and finally using the Trivial File Transfer Protocol (“TFTP”) to download an operating system.

DHCP is a communications protocol that lets network administrators manage centrally and automate the assignment of Internet Protocol (IP) addresses in an organization's (or home user) network. Using the Internet Protocol, each machine that can connect to the Internet or intranet generally requires a unique IP address. When an organization sets up its computer users with a connection to the Internet or intranet, an IP address is typically assigned to each machine. Without DHCP, the IP address would be entered manually at each computer. DHCP lets a network administrator supervise and distribute IP addresses from a central point and can automatically send a new IP address when a computer is plugged into a different place in the network.

ARP is a protocol for mapping an IP address to a physical machine address that is recognized in the local network. For example, in IP Version 4, the most common level of IP in use today, an address is 32 bits long. In an Ethernet local area network, however, addresses for attached devices are 48 bits long. (The physical machine address is also known as a Media Access Control or MAC address.) A table, usually called the ARP cache, is used to maintain a correlation between each MAC address and its corresponding IP address. ARP provides the protocol rules for making this correlation and providing address conversion in both directions. This can be used to guarantee that one and only one device is assigned a particular IP address.

For example, when ARP is used, an incoming packet destined for a host machine on a particular local area network arrives at a gateway. The gateway asks the ARP program to find a physical host or MAC address that matches the IP address. The ARP program looks in the ARP cache and, if it finds the address, provides it so that the packet can be converted to the right packet length and format and sent to the machine. If no entry is found for the IP address, ARP broadcasts a request packet in a special format to all the machines on the LAN to see if one machine knows that it has that IP address associated with it. A machine that recognizes the IP address as its own returns a reply so indicating. ARP updates the ARP cache for future reference and then sends the packet to the MAC address that replied.

The last step of the BOOTP process is the actual transfer of data from the server to the target device. To accomplish this task, a protocol is necessary for the orderly transfer of the data. A protocol, in general, provides a routine for the devices to follow when communicating with each other, and also provides a routine that will be employed when, for any reason, a failure occurs. There are, theoretically, many possible protocols that could be established to facilitate the orderly transfer of information between the two devices. In practice, the protocol that is typically used for such downloading is TFTP. TFTP is an Internet Engineering Task Force(“IETF”) standard. This protocol provides for transfer of data in discrete “packets.” The process employed by TFTP to transfer data packets from the server device to the target device is illustrated in FIG. 1.

Referring to FIG. 1, the TFTP process can be conceptually understood with reference to a flowchart that describes the actions of the devices involved. FIG. 1 describes the steps followed by a “device” and a “server.” The server is downloading data to the device. First, the device is turned on (Box 1). Next, the device broadcasts a request (Box 2). The device does this by sending a request to a broadcast address on the network (not shown here) which the device is in communication with. Servers on the network will discover that the device has been turned on and has requested communication. Next, one of the servers will respond to the device by unicasting a first data packet (Box 3). The server does this by sending the first data packet to a unicast address on the network. After the device recovers the first data packet from the unicast address, the device acknowledges to the server that it successfully received the first data packet (Box 4). At this point, the device and the server are in communication with each other and are proceeding with the download of data. This download process occurs in Box 5-Box 7. As illustrated in FIG. 1, it is very simple. The server sends a data packet (Box 5), and then the device acknowledges receipt of the data packet (Box 6). Unless the data packet was recognized by the device as the last data packet (Box 7) the steps of sending (Box 5) and acknowledging (Box 6) are repeated for each and every data packet. When the last data packet arrives, the device acknowledges the receipt of the last data packet and the download process is complete (Box 8).

A data download protocol, such as TFTP, should have a routine in place for the inevitable situation in which data is not successfully transferred from the server to the device. As illustrated in FIG. 2, the TFTP error procedure ensures that the device receives each and every data packet. Note that FIG. 2, like the other figures in this document, refers to elements already shown in previous figures with the same number. Therefore, Box 4 in FIG. 2 is the same as Box 4 in FIG. 1. FIG. 2 illustrates a download in progress, which is interrupted by a transmission error (Box 5(A)). One of the data packets did not successfully arrive at the device. The TFTP protocol deals with this situation through time-out. The device will simply wait to receive the next data packet for a specified amount of time, typically one full second (Box 5(B)). If the packet does not arrive, the device retransmits its previous acknowledgement to the server (Box 5(C)). While, for ease of illustration, FIG. 2 shows the previous acknowledgement as also the acknowledgement of the first data packet, the device can in fact acknowledge its previous data packet no matter where in the download process the error occurs (it need not go all the way back to the first acknowledgment). The server, upon receipt of the acknowledgement, will transmit the data packet following the last acknowledged data packet (Box 5). The process then continues normal operation, as illustrated in FIG. 1. In this way, TFTP ensures that each and every packet was successfully transmitted from server to device.

The use of TFTP as a data download protocol has at least one major drawback: it is slow. By establishing a protocol in which the server waits for an acknowledgement from the device prior to sending the next data packet, TFTP does not allow the server and device to operate simultaneously. Also, the acknowledgement of each and every data packet by the device takes extra time. To elaborate, consider the fact that every action taken by the device and the server absorbs some small amount of time. First, the device sends the acknowledgement packet. Then the network transmits it to the server. Then the server recognizes the packet. Then the server may send it to the appropriate subroutine within the server for processing. Then the server generates a response. Then the server transmits the response, and so on. By engaging this process for every data packet, TFTP absorbs a great deal of extra time in data transmissions.

Another reason TFTP takes additional time is the way in which it deals with transmission failures. Discovery of failures through a time-out procedure absorbs additional time in the download when the server and device could otherwise be actively working on a remedy for the transmission failure.

Download time becomes an important issue when substantial amounts of data are transmitted. This is true, for example, in the case of the Bobsled. The Bobsled's operating system is quite large, approximately 8 megabytes. On 100 megabit-per-second wired networks (e.g., 100 baseT), an operating system download to the Bobsled using TFTP may take around 10 seconds. On a 10 megabit-per-second wired network (e.g., 10 baseT), an operating system download to the Bobsled using TFTP may take around 24 seconds.

Another drawback of TFTP is the way in which communications are established between the device and the server. Referring again to FIG. 1, observe that the TFTP procedure includes the device broadcasting a request (Box 2) a server unicasting a first data packet (Box 3), and the device acknowledging the first data packet (Box 4). This procedure may lead to additional complexity when multiple potential servers are available on a network to download data to the device. For example, there may be a procedure in place for determining which server will communicate with the device. Therefore, the download of data using TFTP involves extra time and complexity that become a problem especially when downloading large amounts of data. A need exists in the industry for a data transfer protocol that allows for faster downloads to devices.

### SUMMARY OF THE INVENTION

The present invention provides a method and system for downloading data from one device to another. Herein, the device that includes the data to be downloaded, when referred to alone, is called the server. The device that receives the data is called the device. When referred to collectively, they are called “the devices.” The present invention provides systems and methods for using data packets that are exchanged by the server and the device. Some packets may not contain data for download, but rather may be for the purpose of communications between the devices.

In various non-limiting exemplary embodiments, device discovery and server selection processes in accordance with the invention proceed as follows. First, the device broadcasts a discovery packet that informs servers on a network that the device requests a data download. Then, available server(s) on the network can send an offer packet to the device, informing the device that the server(s) are prepared to download data to the device. Next, an offer is selected from the offer packet(s), e.g., the device chooses an offer and sends a start packet to the chosen server to request download initiation. Upon receipt of the start packet, the chosen server begins downloading data to the device.

In various non-limiting exemplary embodiments, data to be downloaded from the server is divided into packets that are identifiably ordered, e.g., numbered sequentially. The server may send a selected limit of data packets to the device before it will stop and wait for an acknowledgement from the device. Upon receiving an acknowledgement, the server may again send up to the limit of data packets to the device before again waiting for acknowledgement.

In one embodiment of the invention, the device sends acknowledgements to the server before the device has received the number of packets that the server is permitted to send. For example, if the server is permitted to send a limit of 8 packets (prior to receipt of an acknowledgement), the device may send an acknowledgement every 4 packets. In this way, the device and the server may operate simultaneously, which shortens download time.

Upon receipt of the last data packet in the sequence, the device sends a stop packet to the server, and the server returns to idle. The data download is complete.

### BRIEF DESCRIPTION OF THE DRAWINGS

FIG. 1 is a flowchart demonstrating the standard data download procedure employed by TFTP (Prior Art).

FIG. 2 is a flowchart demonstrating the procedure employed by TFTP to resolve errors in downloading data.

FIG. 3 is a flowchart demonstrating the normal data download procedure (i.e., the procedure in the absence of errors) of the present invention, referred to as NPL.

FIG. 4 is a flowchart demonstrating the procedure employed by NPL for a particular type of download error, namely the sending of redundant data packets by the server.

FIG. 5 is a flowchart demonstrating the demonstrating the procedure employed by NPL for a particular type of download error, namely the skipping of a data packet in the sequence.

FIG. 6 is a flowchart demonstrating the procedure employed by NPL for a particular type of download error, namely the failure of data packets to timely arrive at the device.

FIG. 7 is a table demonstrating the NPL states of a device, the possible events that may trigger action by the device when the device is in those states, and the resulting state transitions and actions that the device undertakes when the possible events occur.

FIG. 7A is a table demonstrating the various actions a device may undertake when it is in a RECEIVING(m) state and a data packet arrives.

FIG. 8 is a table demonstrating the NPL states of a server and the state transitions of the server and actions the server undertakes upon occurrence of the possible events listed in FIG. 7.

FIG. 9 is an exemplary network environment.

FIG. 10 is an exemplary computing device.

### DETAILED DESCRIPTION OF ILLUSTRATIVE EMBODIMENTS

This invention provides an improved protocol for downloading data from one device to another. In one embodiment, the present invention is used in conjunction with additional processes described herein to improve the download of operating systems to “reduced cost” devices, i.e., devices that lack sufficient local disk memory to store their own operating system. Certain specific details are set forth in the following description and figures to provide a thorough understanding of various embodiments of the invention. Certain well-known details often associated with data downloads and/or networked computing environments are not set forth in the following disclosure, however, to avoid unnecessarily obscuring the various embodiments of the invention. Further, those of ordinary skill in the relevant art will understand that they can practice other embodiments of the invention without several of the details described below.

When used in conjunction with the BOOTP process for downloading an operating system to a reduced cost device, the present invention provides a protocol that can replace TFTP. In other words, the present invention can be substituted for TFTP as the last step of the BOOTP process. As explained in the background section the BOOTP process usually involves three steps: first using DHCP to get an IP address, then using ARP to verify that no other device is using the IP address, and finally using TFTP to download an operating system. The present invention provides a tool to replace TFTP in this three-step process. For purposes of this description, the present invention will be called the Network Program Loader protocol (“NPL”). When used in conjunction with the BOOTP process, the steps for downloading an operating system include using DHCP to get an IP address, using ARP to verify that no other device is using the IP address, and using NPL to download an operating system.

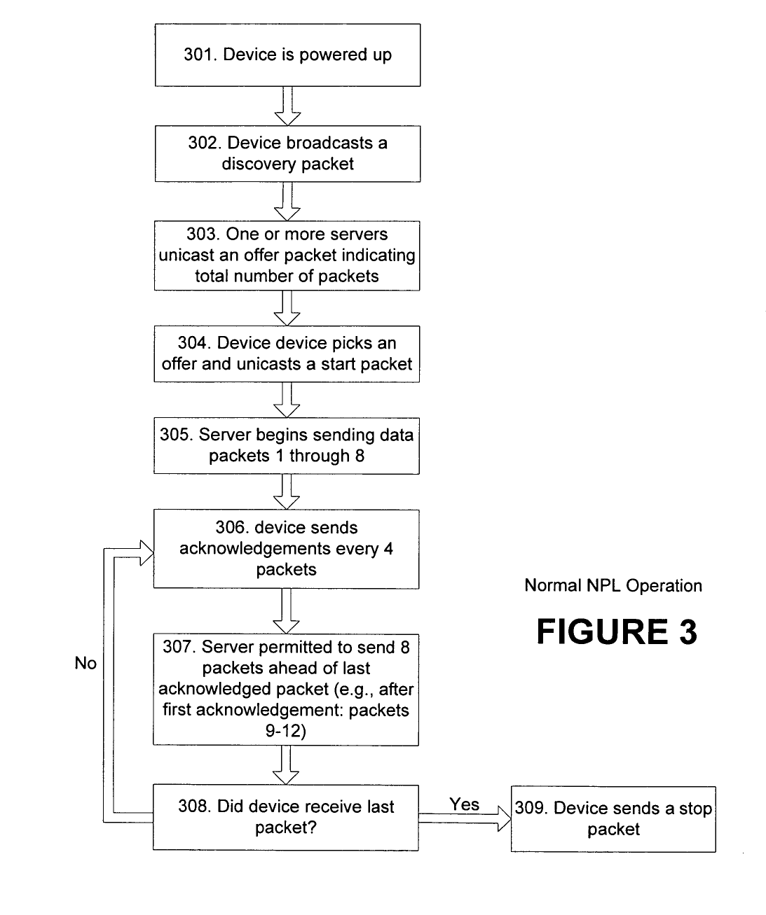

FIG. 3 is a flow chart that describes the steps followed during standard operation by a “device” and a “server” in accordance with the present invention. The terms “device” and “server” are used here to identify the components involved, but because they are both electronic devices, they may occasionally be referred to collectively as devises. If it is helpful, they can be thought of as a “Bobsled” and an “MCE” as described in the Background section. It should be born in mind, however, that both the server and the device can be any of a huge variety of electronic devices connected over a network.

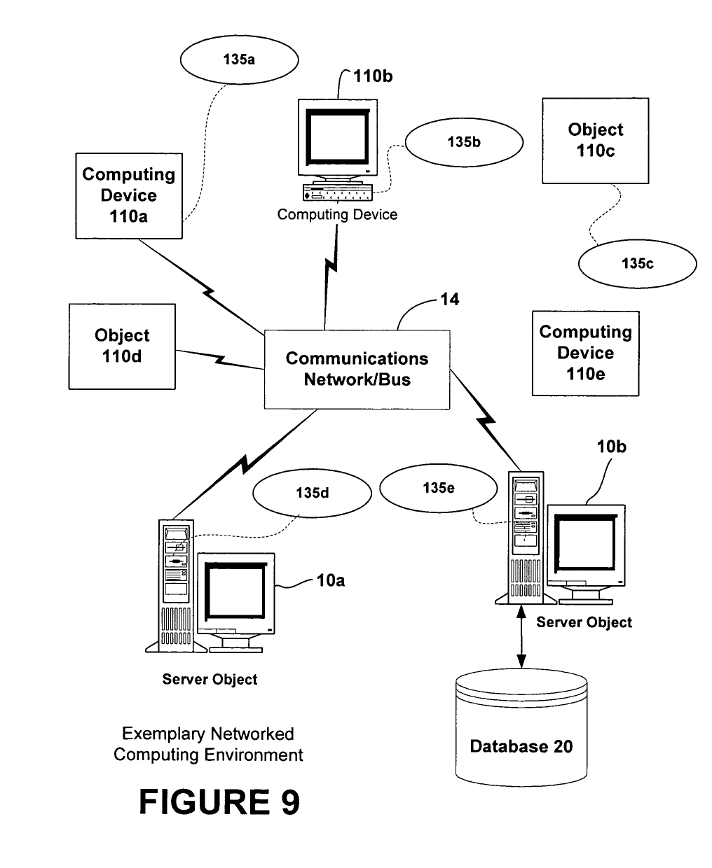

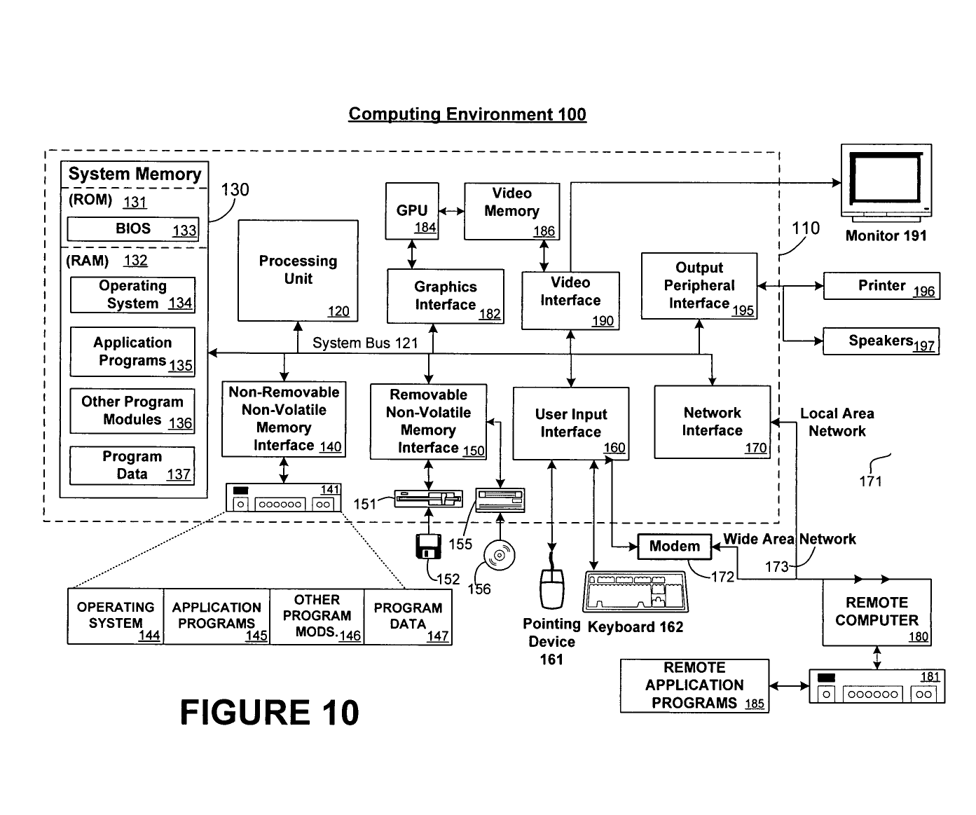

FIG. 9, FIG. 10, and the following discussion are intended to provide a brief general description of a network and computing devices with which the invention may be implemented. FIG. 10 thus illustrates an example of a suitable computing device 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100. Indeed, one likely use of the data download techniques of this invention is for downloading operating systems to reduced cost devices, which may omit some of the components in FIG. 10 to reduce costs. The “server” of FIG. 3, on the other hand, is more likely to comprise the elements of a computing device as shown in FIG. 10, as well as additional elements not shown.

With reference to FIG. 10, an exemplary system for implementing the invention includes two or more general purpose computing devices, each in the form of computer 110. Components of computer 110 may include, but are not limited to, a processing unit 120, a system memory 130, and a system bus 121 that couples various system components including the system memory to the processing unit 120. The system memory 130 in reduced cost devices may be either very limited or nonexistent, while the system memory of the “server” of FIG. 3 is likely to be more typical of a standard computing device. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 10 illustrates operating system 134, application programs 135, other program modules 136, and program data 137.

The computer 110 may also include other removable/non-removable, volatile/nonvolatile computer storage media. By way of example only, FIG. 10 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 10 provide storage of computer readable instructions, data structures, program modules and other data for the computer 110. In FIG. 10, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

Although not required, the invention can be implemented via an operating system, for use by a developer of services for a device or object, and/or included within application software that operates in connection with the data download techniques of the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

The present invention may also be applied internally to standalone computing devices, having programming language functionality, interpretation and execution capabilities for generating, receiving and transmitting information in connection with remote or local services. NPL is particularly relevant to those computing devices operating in a network environment, and thus the data download techniques in accordance with the present invention can be applied with great efficacy in those environments.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 10. The logical connections depicted in FIG. 10 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 10 illustrates remote application programs 185 as residing on memory device 181. It will be appreciated that the network connections shown are exemplary and other means of establishing a communications link between the computers may be used.

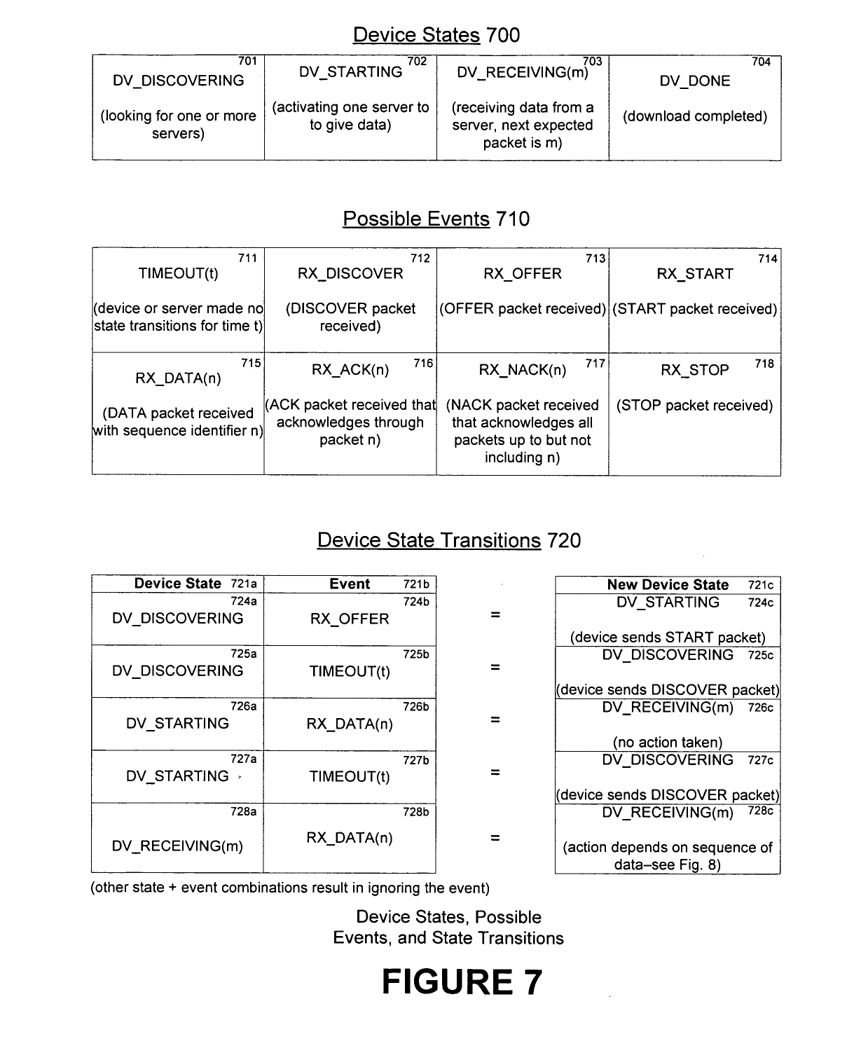

FIG. 7 provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 14. This network may itself comprise other computing objects and computing devices that provide services to the system of FIG. 9, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the data download processes in accordance with the invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to data downloads according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11 B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge as protocol standards may be interconnected to form a network, such as an intranet, that may be connected to the outside world by way of the Internet. In short, a variety of disparate sources exist for the storage and transmission of data, and consequently, moving forward, computing devices will require ways of sharing data, such as data accessed or utilized incident to program objects, which make use of NPL in accordance with the present invention.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. In FIG. 3, the “device” can be thought of as a client while the “server” can be thought of as a server. The device process utilizes the requested service without having to “know” any working details about the other program or the service itself. In a client/server architecture, particularly a networked system, a client is usually a computer that accesses shared network resources provided by another computer, e.g., a server. In the example of FIG. 9, computers 110a, 110b, etc. can be thought of as clients and computers 10a, 10b, etc. can be thought of as the server where server 10a, 10b, etc. maintains the data that is then replicated in the client computers 110a, 110b, etc., although any computer can be considered a client, a server, or both, depending on the circumstances. Any of these computing devices may be processing data or requesting services or tasks that may implicate the data download techniques of the invention.

A server is typically a remote computer system accessible over a remote or local network, such as the Internet or an intranet. Indeed, increasingly American families possess more than one computing device in their homes which may be networked according to a client/server architecture. The client process may be active in a first computer system, and the server process may be active in a second computer system, communicating with one another over a communications medium, thus providing distributed functionality and allowing multiple clients to take advantage of the information-gathering capabilities of the server.

Client(s) and server(s) communicate with one another utilizing the functionality provided by protocol layer(s). One such protocol layer is the NPL disclosed in this description. Other protocols are, for example, HyperText Transfer Protocol (HTTP), a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 9 illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to download data from one device to another. It is expected that more reduced cost devices will enter the market, and that devices such as stereo speakers, lights, telephones and the like will require operating system downloads when turned on.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the data download techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of a single server downloading data to a reduced cost device, the invention is not so limited, but rather may be implemented to provide data downloads from any computing device to any other computing device, as those terms are described herein. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

The present invention, referred to as NPL, provides a technique for transferring data from one device to another over a network. To that end, the present invention utilizes sequentially identified discrete data “packets,” similar to the packets used by TFTP. Those skilled in the art will recognize that the size of the data packets may vary. The present invention is not limited to any one particular size of data packets, and it is expected that data packets of various sizes will be used in accordance with the present invention.

As will soon be described, the present invention involves transfer of data packets that fit various descriptions. For example, there are OFFER packets, ACK packets, DATA packets, etc. These packets generally contain data that, when received at either the server or the device, is capable of transmitting to the recipient a message that generally corresponds to the common meaning of the word identified in the name of the data packet. Thus, the OFFER packet is capable of making known to the device that the server is prepared to download data. The ACK packet is capable of informing the server (“acknowledging”) that packets through a certain sequence identifier were successfully received. In practice, these messages are typically not in plain English, but rather carry some piece of information that is used by the receiving device in such a way that the effect is to “offer” or “acknowledge” or “transmit data,” etc. There are many ways to configure devices such that the effect of a piece of data is to “offer,” “acknowledge,” etc., and those skilled in the art will recognize that the present invention is not limited to one particular method of doing so.

The packets described above are generally arranged in sequence to facilitate their orderly transfer from one device to another. While a sequence of data packets is employed by this invention, it should be stressed that the particular method of providing a sequence identifier for the data packets may be easily varied and adapted to the needs of a particular system. For example, some methods might use numbers as identifiers and begin at zero. Others may begin at 50, 100, or some other integer or decimal value. Letters may also be used as identifiers. A sequence may be linear, e.g., 1, 2, 3, etc. or it may proceed according to some function such as 1, 4, 7, 10, 13, etc. or 0, 1, 4, 5, 8, 9, 12, 13, 16, 17, etc. While for ease of description the sequence identifier may be called a number and in may be assumed that the sequence is simply a linear count, the invention is not so limited.

Returning to FIG. 3, the server in this flowchart is downloading data to the device. FIG. 3 illustrates an embodiment of the invention in which NPL is used as part of the BOOTP process. When not used as part of the BOOTP process, those skilled in the art will recognize that the steps of Box 301, 302, 303, and 304 may become unnecessary. In this scenario, the protocol described herein is used without the introductory subroutine to simply transmit data from one device to another in a setting where the devices have already established communication with each other via some other means. The techniques for such transmission will become clear in the broader discussion below. In other contexts, the steps of Box 301, 302, 303, and 304 may be used independently of the download subroutine represented by the boxes that follow. In general, although this invention is designed to function as a whole, various subroutines may be broken off and applied in combination with other subroutines. The present invention is not limited to the use of all of the subroutines in conjunction with each other, although the combination is presented here as a unified whole for the purpose of providing a clear and straightforward description.

First, the device is turned on, Box 301. Next, the device broadcasts a discovery packet, Box 302. The device does this by sending a request to a broadcast address on the network (not shown here) which the device is in communication with. The discovery packet is then available to the network, and servers on the network will discover that the device has been turned on and has requested communication. Any available server can unicast an offer packet to the device, Box 303, which informs the device that the server is prepared to download data to the device. Offer packets may also provide the total number of packets in the download, Box 303. A server unicasts an offer packet by sending it to a unicast address on the network. The device may choose any of the incoming offer packets. The choice may be optimized by choosing the first offer packet that arrives, or by using other criteria to best choose which offer packet to respond to. In any case, the device picks an offer and unicasts a start packet to the chosen server, Box 4. At this point, the device and the server are in communication with each other and are proceeding with the download of data.

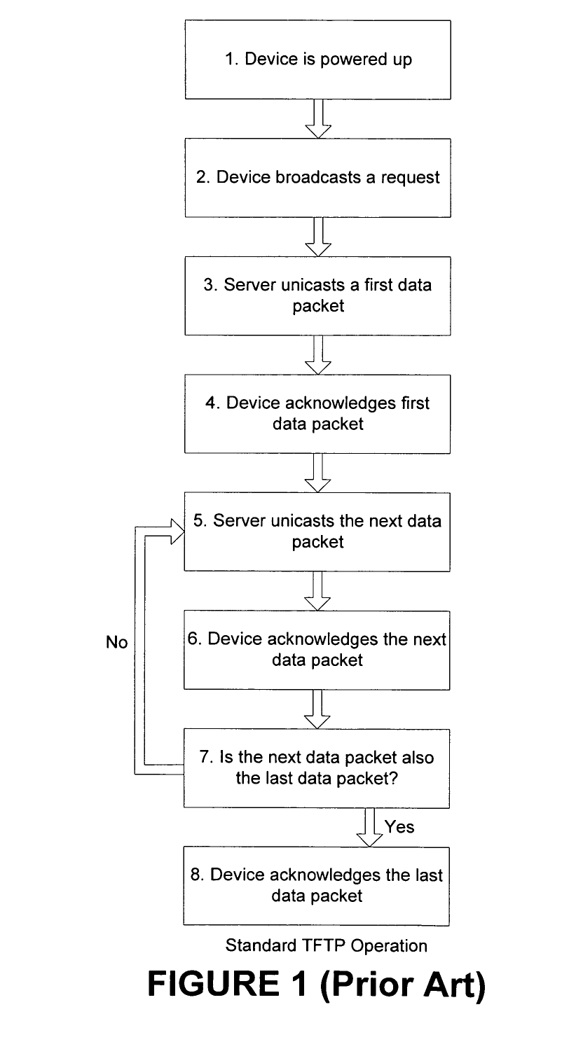

The download process occurs in Box 305-Box 308. In comparison with the TFTP download process of FIG. 1, the NPL download process adds slight additional complexity while remaining “lightweight,” i.e., it does not require either device to store very much information in the form of either data storage or circuitry logic. In return for the additional complexity, NPL can deliver a marked increase in download speed. It does this primarily by through two advantages over TFTP, although other advantages may certainly be recognized: first, it allows the server to send many packets before it waits for an acknowledgement, and second, it allows the device to send acknowledgements (of received packets) before the server waits.

Recall from the Background section that on 100 megabit-per-second wired networks (e.g., 100 baseT), an operating system download of 8 megabytes using TFTP may take around 10 seconds. On a 10 megabit-per-second wired network (e.g., 10 baseT), the same download using TFTP may take around 24 seconds. By substituting NPL for TFTP, the operating system download times may be increased to 1 second and 8 seconds, respectively. In tests of the invention, efficiency gains have been even greater when the communication path runs across store and forward devices, such as switches and routers.

Instead of the one packet/one acknowledgement protocol used by TFTP and illustrated in FIG. 1, NPL allows the server to send multiple packets before waiting for an acknowledgement from the device, Box 305. The number of packets is shown in FIG. 3 (8 packets), Box 305, but any practical number of packets may be sent at a time in accordance with the present invention. As the server receives acknowledgements from the device, it is permitted to send out additional packets, up to the selected number (here 8) ahead of the last acknowledged packet, Box 307. For example, the server will send out packets 1-8. At some point during or after sending packets 1-8, the server may receive an acknowledgement from the device that packet 4 was received. At that point, the server is permitted to send packets through packet 12. Then the server receives an acknowledgement for packet 8, and server may send through packet 16, and so on until the last packet is sent, and the server receives a stop packet sent by the device, Box 309.

From the perspective of the device, it begins receiving packets after unicasting its start packet, Box 304. After receiving some number of packets less than the amount of packets sent out by the server, the device may send an acknowledgment, Box 306. The interval at which the device sends acknowledgements is shown as four in Box 306, but any practical number may be selected in accordance with this invention. The acknowledgement may indicate the next packet that the device expects to receive. Following the acknowledgement, the device continues to receive packets from the server until it is time for the next acknowledgement, Box 306. Efficiency is enhanced by using this technique because the server and the device spend less time waiting for each other than in TFTP.

Note that if the device operates much slower than the server, use of NPL may result in a situation where for example, using the numbers of FIG. 3, the server easily remains 8 packets ahead of the device. In this situation, the server receives an acknowledgement of, for example, packet 12, and then quickly sends packetsl6 through 20. The server then waits for an acknowledgement of packet 16 and then quickly sends packets 20 through 24. While the sever may loose time waiting in this exemplary system, efficiency is nonetheless enhanced at the device, because the processing power of the device is being fully utilized, either sending acknowledgements or receiving data packets.

When the device has received all of the packets indicated in the offer packet, Box 303, the device may send out a stop packet, Box 309, and the download process is complete.

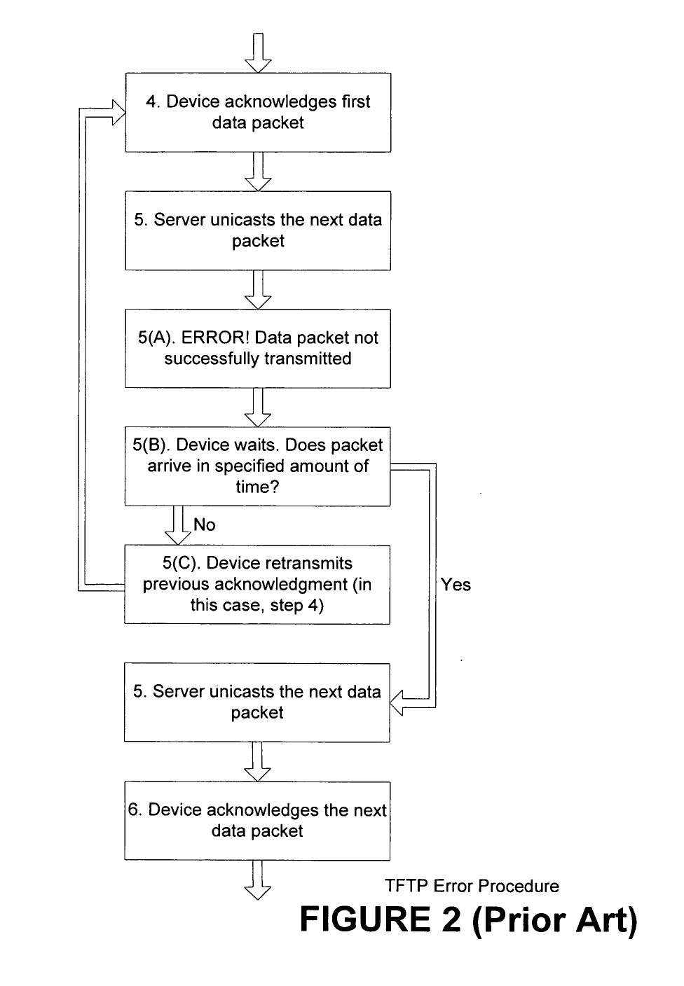

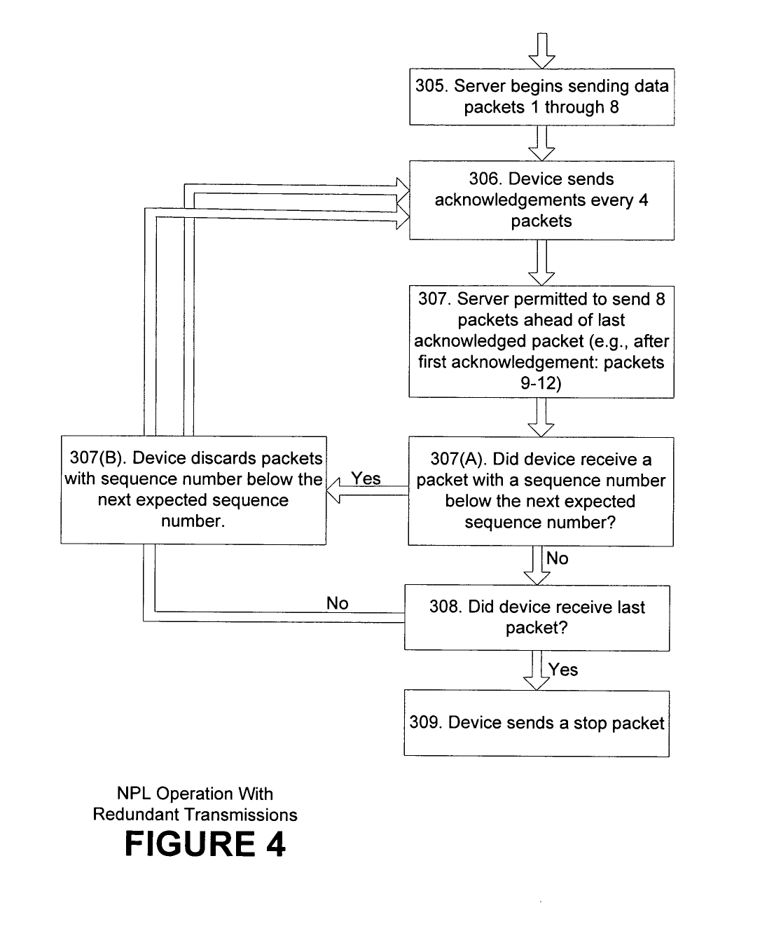

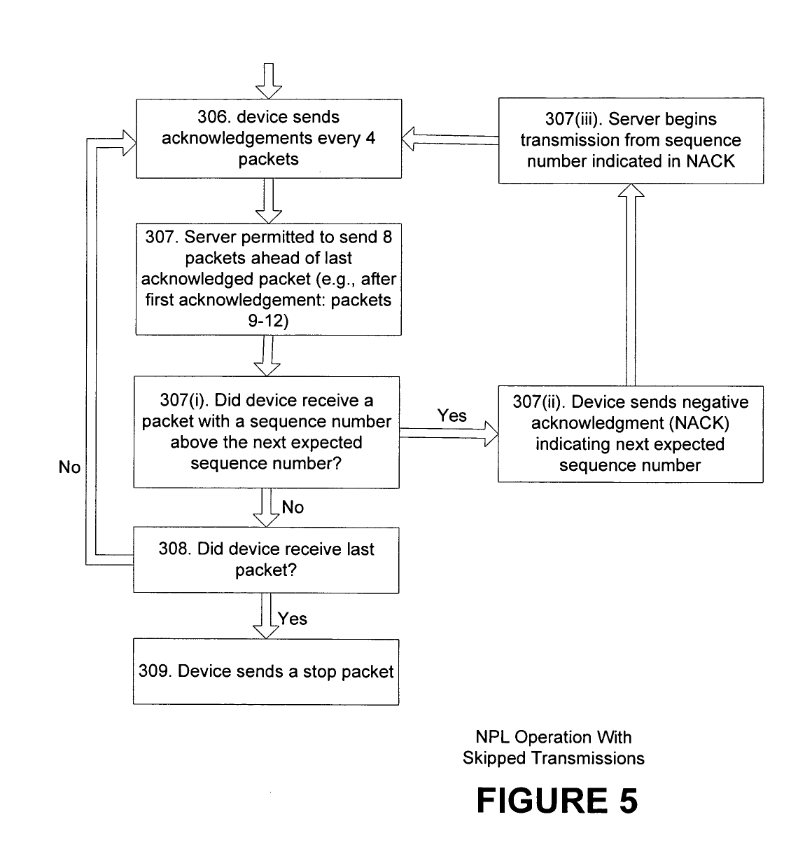

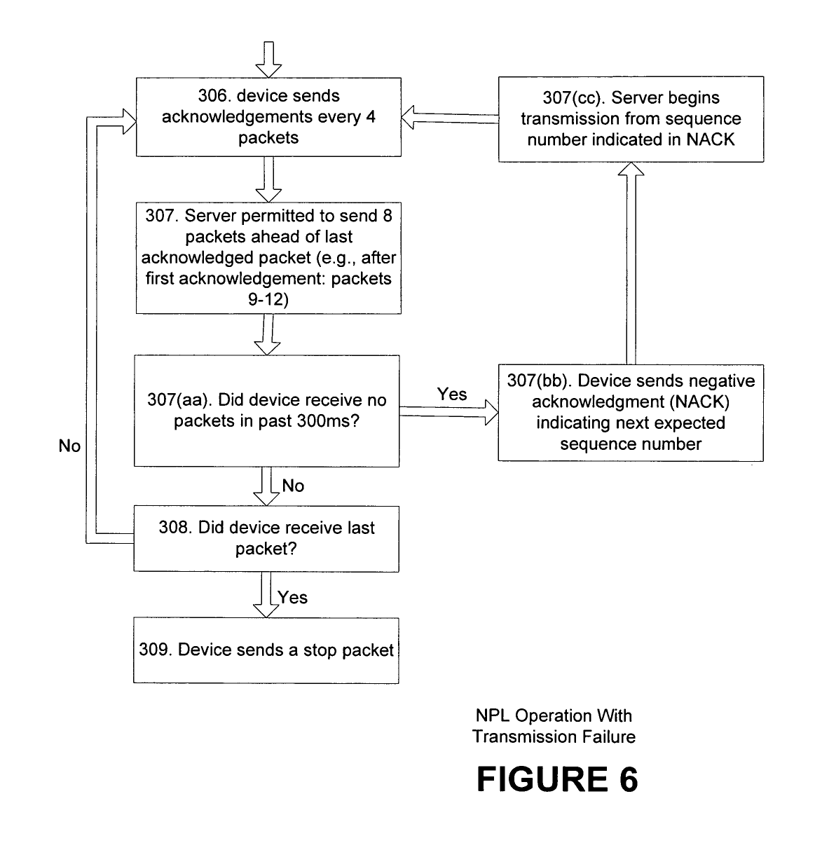

FIGS. 4, 5, and 6 correspond to FIG. 2 in that they illustrate the routine in NPL for the inevitable situation in which data is not successfully transmitted from the server to the device, just as FIG. 2 demonstrated the error routine in TFTP. While TFTP has a single solution for all transmission errors, i.e., time-out and retransmission of the previous acknowledgement, NPL optionally has three or more solutions depending on the type of error that occurs. Three solutions are illustrated in embodiments of the present invention represented by FIG. 4, FIG. 5, and FIG. 6, respectively.

FIG. 4 illustrates in a flow chart the simple solution that may be employed by an embodiment of the present invention when the device receives redundant transmissions from the server. For example, consider a situation in which the device has sent an acknowledgement of packet 12, and received packets 13, 14, and 15. Instead of receiving packet 16 next, however, device receives packets 13, 14, and 15 again. The solution is for the device to discard the redundant data. In FIG. 4, this process is represented by providing the normal operation of a data download in Box 306 and Box 307. Box 307(A) then presents the receipt of redundant packets at the device. If this occurs, the redundant packets are discarded, Box 307(B), and the data download continues normal operation, as in Box 306 and Box 307. In the example above, where the device received redundant packets 13, 14, and 15, assume further that afterwards the device received packet 16. Packet 16 could be accepted and acknowledged pursuant to normal download procedure.

FIG. 5 illustrates in a flow chart a solution that may be employed by an embodiment of the NPL protocol when a packet that was expected is not received at the device, but later packets in the download system were received. To borrow from the example above, consider a situation in which the device has sent an acknowledgement of packet 12. It then receives packet 13, 15 and 16, but not packet 14. The solution is for the device to send a negative acknowledgement (“NACK”) indicating packet 14. The server, upon receipt of the NACK, will back up and begin sending packets starting at the indicated packet. Note that the NACK, in addition to indicating the skipped packet, effectively acknowledges the receipt by the device of all packets prior to the skipped packet. For example, by sending a NACK indicating packet 14 was skipped, the device effectively acknowledges receipt of packet 13. For this reason, the server may, on receipt of a NACK, send up to 8 packets (in.this example) in advance of the NACK. The server need not use only acknowledgements (“ACKs”) to calculate which packets to send, it can also use NACKs.

Turning to FIG. 5, again Box 306 and Box 307 represent the normal operation of NPL data download. Box 307(i) shows that one or more packets may have been skipped. In this case, the device sends a NACK to the server, Box 307(ii). The server begins transmission at the sequence identifier specified in the NACK, Box 307(iii). After the server has backed up to the place of error as indicated in the NACK, normal operation resumes, Box 306 and Box 307.

FIG. 6 illustrates in a flow chart the procedure that may be followed by an embodiment of the invention when transmission fails by nontransmission of packets. In other words, the device receives no packets for a specified time period. The exemplary period used in FIG. 6 is 300 milliseconds (“ms”), but those skilled in the art will recognize that any time period could be specified. The solution employed in this scenario, like the solution employed in the embodiment of FIG. 5, is for the device to send a NACK to the server indicating the nontransmitted packet. Just as in the FIG. 5 embodiment, the server can react to the receipt of a NACK by backing up and sending packets beginning at the packet identified in the NACK. In FIG. 6, as in previous figures, Box 306 and Box 307 represent the normal operation of the NPL data download. Box 307(aa) then shows the device, although in a packet receiving state (not all data downloaded), fails to receive a packet for a specified amount of time (here, 300 ms). The solution is to send a NACK to the server, Box 307(bb). The server begins transmission at the sequence identifier specified in the NACK, Box 307(cc). After the server has backed up to the place of error as indicated in the NACK, normal operation resumes, Box 306 and Box 307.

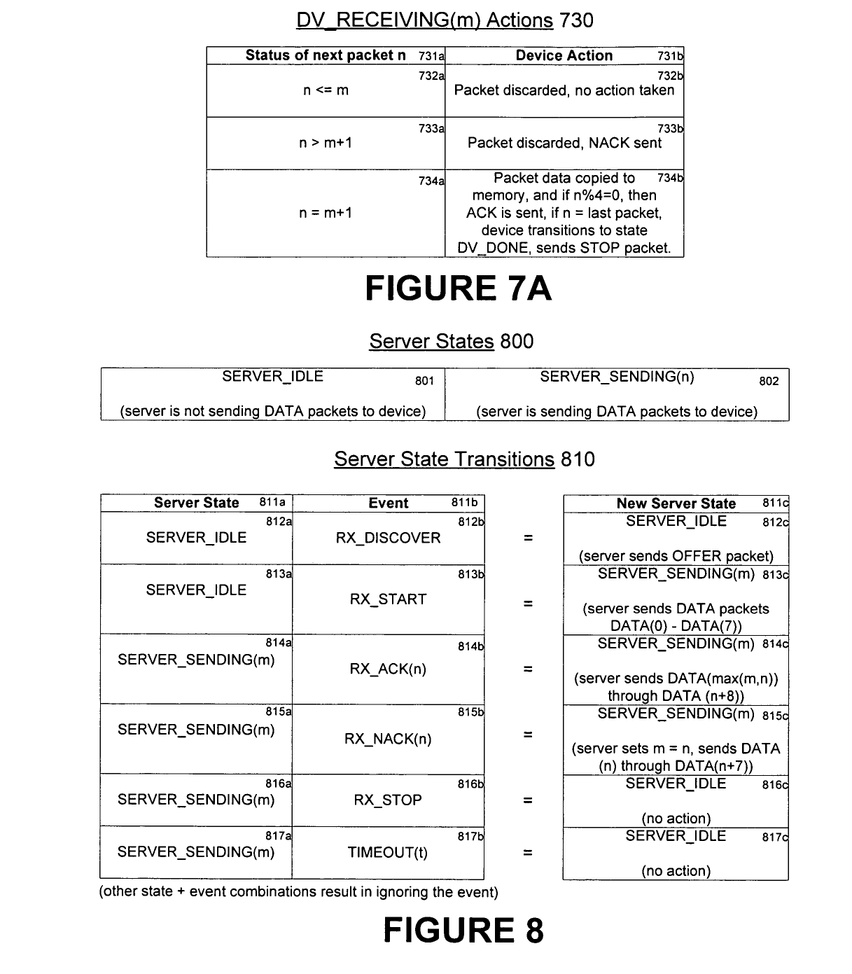

FIG. 7 further explains an exemplary embodiment of the present invention by providing a diagram of device states 700, possible events 710, and device state transitions 720 that take place when the possible events 710 occur. The invention may be implemented using four device states 700. These four states can determine how the device may respond to the various possible events 710 that may occur. As shown in FIG. 7, the four optional states are DISCOVERING 701, STARTING 702, RECEIVING(m) 703, and DONE 704. The comments in parenthesis in the boxes of FIGS. 7 and 8 describe the actions that the device and/or server take when in the named state or upon transitioning into the named state. The description here is not intended to limit the actions that may be taken by the devices when in any given state, or to imply that certain actions may only be taken when in a given state. It is rather directed to demonstrating an instructive embodiment of the present invention, which may be adapted to various network environments and devices, as described above. When in the DISCOVERING state 701, the device is generally looking for one or more servers available download data. When in the STARING 702 state, the device is taking actions in accordance with activating one or more servers to provide data. When in the RECEIVING(m) 703 state, the device is receiving data from a server, wherein the device is expecting a packet with a sequence identifier following the sequence identifier of the last packet received. In FIG. 7, the sequence number of the expected packet is represented by the variable m 703. When in the DONE state, the download is completed and the device is no longer responding or recording incoming packets associated with the completed download.

The table of possible events 710 provides a non-limiting list of the possible events that may occur while the device is in any given state 700. To determine how the device will react to the events 720, refer to the device state transitions table 720. The events are TIMEOUT(t) 711, in which either the device or the server made no state transitions for a specified amount of time (t); RX_DISCOVER 712, in which a DISCOVER packet is received by one of the devices; RX_OFFER 713, in which an OFFER packet is received by one of the devices; RX_START 714, in which a START packet is received by one of the devices; RX_DATA(n) 715, in which one of the devices receives a DATA packet with a sequence identifier, represented here by the variable n; RX_ACK(n) 716, in which the server receives an ACK packet that acknowledges receipt of all packets through DAT(n); RX_NACK(n) 717, in which the server receives a NACK packet that acknowledges all DATA packets up to but not including n; and RX_STOP 718, in which one of the devices receives a STOP packet.

As mentioned above, the device states 700 can be used to determine the state transitions and corresponding actions taken by the device when possible events 710 occur. The table of device state transitions 720 provides an embodiment of the invention in which a set of device states 721a and possible events 721b have been assigned a corresponding new device state 721c and any accompanying action by the device. In this embodiment, the transitions shown in the device state transitions table 720 are the only combinations of state 700 and event 710 that will result in any action or state transition. This embodiment is not intended to limit the invention to the combinations shown, but rather to demonstrate the concept that the relevant state 700 and event 720 combinations may be restricted to provide the functionality desired.

The device state transitions table 720 demonstrates that when the device is in the DISCOVERING state 724a and receives an OFFER packet 724b, the result is that the device goes into the STARTING state and sends out a start packet 724c. If the device is in the DISCOVERING state 725a and a TIMEOUT(t) event occurs 725b, the result is that the device remains in the DISCOVERING state, and sends out another DISCOVER packet 725c. When the device is in the STARTING state 726a and receives a DATA packet 726b, the result is that the device transitions into a RECEIVING(m) state, and takes no other action 726c. Usually, upon transitioning from a STARTING state 702 to a RECEIVING(m) state 703, the device will soon be receiving the first DATA packet. Because the device in this embodiment keeps track of which DATA packets were received and which DATA packets it expects to receive next, the device may begin by setting the variable m equal to zero, or may use any other identifier that indicates a starting point to both the device and the server. When the device is in a STARTING state 727a TIMEOUT(t) event occurs 727b, the result is that the device switches back into a DISCOVERING state and sends another DISCOVER packet 727c. When the device is in a RECEIVING(m) 728a state and receives a DATA(n) packet 728b, the device transitions into a RECEIVING(m) state, wherein the variable m has been updated 728c. The device also takes one or more actions, depending upon the character of the DATA(n) packet received 728c.

To determine the additional actions that the device may take upon transitioning into a new RECEIVING(m) state 728c, refer to FIG. 7A. As illustrated, if the packet sequence identifier of the incoming packet DATA(n) 728b is less than or equal to the packet sequence identifier associated with the device state (i.e., DV_RECEIVING(m), see 728a) 732a, then the packet is discarded and no other action is taken 732b. This is the situation where the device is receiving redundant data packets, as described in FIG. 4 and accompanying text. On the other hand, if the packet sequence identifier n is more than one identifier ahead of the packet sequence identifier associated with the device state (i.e., DV_RECEVING(m), see 728a) 733a, then the incoming DATA(n) packet is discarded and the device sends a NACK to the server indicating the sequence identifier (for example, m+1) that the device expected to receive 733b. Note that the expression m+1 is used in FIG. 7A 733a to provide an example of a concept that can be expanded. Naturally, if letters or some other identifiers are used as sequence identifiers, adding 1 to the identifier would be replaced by some other means of indicating the next expected packet. Finally, another action that the device may take upon transitioning from one RECEIVING(m) state to another RECEIVING(m) state occurs when the sequence identifier n of the DATA(n) packet received follows the sequence identifier of the packet associated with the device state 734a. This is the situation where the download is operating normally and there has not been a transmission error. In this situation, the packet DATA(n) is copied to memory 734b. The device will also send out an ACK if the DATA(n) packet was a selected interval ahead of the previous ACK packet 734b. In FIG. 7A, the device is sending acknowledgements every 4 packets 734b, but that number is selected at random and any practical number may be used for an acknowledgement interval.

A representative embodiment of the server can also be illustrated (FIG. 8) by showing the various server states 800 and how the server, when in a particular state 800, responds to various possible events 710. The list of representative events 710 that may be more likely to occur at the server are displayed in FIG. 7 along with the possible events 710 that may more likely occur at the device, and those events are described in this specification in the section corresponding to FIG. 7. The two states that the server may optionally be in, according to this embodiment, are IDLE 801 and SENDING(n) 802. In the IDLE state 801, the server is not sending DATA packets to the device (note, however, that it may take the action of sending an OFFER packet when it receives a DISCOVER packet from the device-see server state transitions 810). In the SENDING(n) state 802, the server is sending data packets to the device. In this embodiment, the server is in a sending state that corresponds to the sequence identifier n. For example, if numbers are used as sequence identifiers, the server can be in state SENDING(0), SENDING(1), SENDING(2), and so on.

FIG. 8 also provides a list of server state transitions and actions that the server may take 810 upon occurrence of the possible events 710. When the server is in IDLE 812a and DISCOVER packet is received 812b, the result is that the server remains in an IDLE state and sends an OFFER packet 812c. When the server is in IDLE 813a and receives a START packet 813b, the result is that the server transitions into a SENDING(m) state, and takes the action of sending the first set of data packets, here DATA(0) through DATA(7) 813c. When the server is in a SENDING(m) state 814a and an ACK(n) packet is received 814b, the server remains in a SENDING(m) state (where m is updated to the next DATA packet sequence identifier every time a packet is sent), and takes the action of sending out DATA packets up to a maximum of a specified interval (here, 8) ahead of either the last acknowledged packet 814c. When the server is in a SENDING(m) state 815a and a NACK is received 815b, the server remains in a SENDING state and resets the sequence identifier of the next packet to the identifier provided by the NACK 815c. When the server is in a SENDING(m) state 816a and receives a STOP packet 816b, the server switches to an IDLE state and takes no further action 816c. This is because the download is complete when the server receives a STOP packet. Finally, when the server is in a SENDING(m) state 817a and a TIMEOUT(t) event occurs 817b, the server switched to an IDLE state, and takes no other action 817c. Just as in table 720, events that occur and are not listed in the server state transitions table 810 may be disregarded.

1. A method for downloading information from a second device to a first device, comprising:
sending a first specified number of identifiably ordered data packets from the second device to the first device;
receiving a first acknowledgment from said first device that a second specified number of said identifiably ordered data packets was received by said first device, wherein said second specified number of said identifiably ordered data packets is less than said first specified number of identifiably ordered data packets; and
sending additional of said identifiably ordered data packets from said second device to said first device, up to said first specified number of identifiably ordered data packets beyond the last of said identifiably ordered data packets acknowledged by said first device.

2. A method according to claim 1, further comprising:
receiving a second acknowledgment from said first device that said second specified number of said identifiably ordered data packets was again received by said first device; and
repeating said sending of additional of said identifiably ordered data packets and said acknowledging again by said first device to said second device until the information is downloaded.

3. A method according to claim 1, further comprising receiving by said second device a discovery packet which informs said second device that said first device requests a data download.

4. A method according to claim 1, further comprising transmitting an offer packet to inform said first device that said second device is prepared to download data.

5. A method according to claim 1, further comprising receiving a start packet from the first device establishing a connection between said second and first device for said second device to begin downloading data to said first device.

6. A method according to claim 1, further comprising receiving by said second device a stop packet which informs said second device that the information is downloaded.

7. A method according to claim 1 wherein said identifiably ordered data packets are sequentially identified data packets.

8. A computer readable medium comprising computer executable instructions for carrying out the method of claim 1.

9. A modulated data signal carrying computer executable instructions for performing the method of claim 1.

10. A computing device comprising means for carrying out the method of claim 1.

11. A computer readable medium comprising computer executable instructions for downloading information from a second device to a first device, the computer executable instructions carrying out a method, the method comprising:
establishing a connection with the first device;
generating at least one identifiably ordered data packet including at least one representation of said information;
sequentially transmitting a number of said at least one identifiably ordered data packets to the first device, wherein said number is determined by comparing a number of data packets transmitted to the first device to the sum of the number of identifiably ordered data packets acknowledged by the first device based upon at least one acknowledgment received by the second device and a second predetermined number of data packets.

12. A computer readable medium according to claim 11 wherein said sequentially transmitting includes transmitting a data packet if the number of data packets transmitted to the first device is less than the sum of the number of identifiably ordered data packets acknowledged by the first device and the predetermined second number of data packets.

13. A computer readable medium according to claim 11 wherein said sequentially transmitting includes waiting to transmit a data packet if the number of data packets transmitted to the first device is greater than or equal to the sum of the number of identifiably ordered data packets acknowledged by the first device and the predetermined second number of data packets.

14. A computer readable medium according to claim 11 wherein said second predetermined number is larger than said first predetermined number.

15. A computer readable medium according to claim 11 wherein the at least one identifiably ordered data packet is at least one sequentially identified data packet.

16. A computer readable medium according to claim 11 wherein said establishing includes receiving a discovery packet from the first device.

17. A computer readable medium according to claim 11 wherein said establishing includes transmitting an offer packet to the first device, wherein said offer packet includes data capable of informing the first device that said second device is prepared to download.

18. A computer readable medium according to claim 11 wherein said establishing further comprises receiving a start packet from said first device, wherein said start packet includes data that informs said second device to begin downloading said information to said first device.

19. A computer readable medium according to claim 11, further comprising receiving a stop packet wherein said stop packet includes data that informs said second device that said first device has received the last packet of said information

20. A computer readable medium according to claim 19, further comprising disestablishing said connection upon receiving the stop packet.

21. A computing device including the computer readable medium comprising computer executable instructions for performing the method, as recited in claim 11.

22. A computer readable medium comprising computer executable instructions for receiving information from a server, the computer executable instructions carrying out a method, the method comprising:
establishing a connection to a server of at least one server;
receiving from the server at least one identifiably ordered data packet including at least one representation of said information;
when a predetermined number of identifiably ordered data packets are received according to said receiving, transmitting an acknowledgment; and
when the last of the identifiably ordered data packets are received according to said receiving, transmitting a stop packet to signify the end of said receiving.

23. A computer readable medium according to claim 22 wherein the at least one identifiably ordered data packet is at least one sequentially identified data packet.

24. A computer readable medium according to claim 22 wherein said establishing includes transmitting a discovery packet to the at least one server.

25. A computer readable medium according to claim 22 wherein said establishing includes receiving an offer packet from the server, wherein said offer packet includes that informs the first device that said server is prepared to download the information to the first device.

26. A computer readable medium according to claim 22 wherein said establishing further comprises transmitting a start packet to said server, wherein said start packet includes data that informs said server to begin downloading said information to said first device.

27. A computer readable medium according to claim 22, further comprising transmitting a stop packet wherein said stop packet includes data for informing said server that said first device has received the last packet of said information

28. A computer readable medium according to claim 27, further comprising disestablishing said connection upon transmitting the stop packet.

29. A computing device including the computer readable medium comprising computer executable instructions for performing the method, as recited in claim 22.

30. Apparatus for downloading information from one device to another, comprising:
means for sending data, wherein said sending includes sending multiple packets of data, up to a specified limit, prior to waiting for acknowledgement of the receipt of said multiple packets of data, after which said means for sending data may send out more data;
means for receiving acknowledgments sent in response to the receipt of data at specified intervals;
means for receiving a message that a packet among said multiple packets of data was not received; and
means for re-sending said packet among said multiple packets of data that was not received.

31. A computer readable medium comprising computer executable modules including computer executable instructions for downloading information from a second device to a first device, the modules comprising:
means for transmitting a first specified number of identifiably ordered data packets from the second device to the first device;
means for receiving a first acknowledgment from said first device that a second specified number of said identifiably ordered data packets was received by said first device, wherein said second specified number of said identifiably ordered data packets is less than said first specified number of identifiably ordered data packets; and
means for transmitting additional of said identifiably ordered data packets from said second device to said first device, up to said first specified number of identifiably ordered data packets beyond the last of said identifiably ordered data packets acknowledged by said first device.

32. A computer readable medium comprising computer executable modules including computer executable instructions for downloading information from a second device to a first device, the modules comprising:
means for establishing a connection with the first device;
means for generating at least one identifiably ordered data packet including at least one representation of said information;
means for sequentially transmitting said at least one identifiably ordered data packet to the first device according to the output of at least one of (A) a means for determining the number of data packets acknowledged by the first device based upon at least one acknowledgment received from the first device, wherein an acknowledgment is sent in response to receiving a first predetermined number of identifiably ordered data packets from the second device and (B) a means for comparing the number of data packets transmitted to the first device to the sum of the number of identifiably ordered data packets acknowledged by the first device based upon at least one acknowledgment received by the second device and a second predetermined number of data packets.

33. A computer readable medium comprising computer executable modules having computer executable instructions for receiving information from a server, the modules comprising:
means for establishing a connection to a server of at least one server;
means for receiving from the server at least one identifiably ordered data packet including at least one representation of said information;
means for transmitting an acknowledgment when a predetermined number of identifiably ordered data packets are received according to said receiving; and
means for transmitting a stop packet to signify the end of said receiving when the last of the identifiably ordered data packets are received according to said receiving.
